(19) United States
(12) Patent Application Publication
(10) Pub. No.: US 2025/0348592 A1
(43) Pub. Date: Nov. 13, 2025

(54) SUBSTANTIATING A COMPLIANCE STANDARD FOR A REGULATED ENTITY

(71) Applicant: Florida Power & Light Company, Juno Beach, FL (US)

(72) Inventors: ROBERT K. WARGO, Riviera Beach, FL (US); CARLOS N. MORALES, Palm CIty, FL (US); BRENTON A. ROBERTS, Stuart, FL (US); RICHARD S. PURVIS, Doral, FL (US)

(21) Appl. No.: 18/662,255

(22) Filed: May 13, 2024

(51) Int. Cl. G06F 21/57; G06F 21/60

(52) U.S. Cl. CPC G06F 21/577; G06F 21/604; G06F 2221/034

(57) ABSTRACT

A method includes identifying the compliance standard based on a regulatory compliance monitoring and enforcement program report. The method includes comparing evidentiary request packages to substantiate the compliance standard from a plurality of regulatory authorities. An evidentiary package defines status indicators of parameters for the regulated entity to meet the compliance standard including a first evidentiary package and a second evidentiary package. The method includes generating an inclusive evidentiary package based on the comparison. The method includes generating an evidentiary submittal package for a first regulatory authority based on the inclusive evidentiary package. The method includes selecting an asset of the regulated entity based on the evidentiary submittal package. The method includes receiving operational data associated with the asset based on the evidentiary submittal package. The method includes applying a compliance result to the compliance standard based on an analysis of the operational data.

### TECHNICAL FIELD

This description relates to substantiating a compliance standard for a regulated entity by identifying an evidentiary package that satisfies multiple jurisdictions.

### BACKGROUND

Regulated entities are businesses that operate in sectors of public importance and are therefore regulated by a centralized regulatory authority. For example, bulk utility systems are regulated entities that operate in the electric, water, oil, or gas sectors. Given the importance of these sectors to society, a centralized regulatory authority monitors the operation and functioning of the bulk utility systems in a territory. For example, NERC (North American Electric Reliability Corporation) compliance standards are the mandatory reliability and security standards that apply to entities that own or manage bulk utility systems that are part of the U.S. and Canadian electrical power grid. Centralized authorities, like NERC, establish the compliance standards for the territory to safeguard the bulk utility system from cyber and/or physical security threats and ensure the reliability of the bulk utility systems. However, regulatory authorities, which are delegated authority to monitor and enforce compliance standards within separate and different jurisdictions within the territory, set the evidentiary requirements that have to be specifically met during audit engagements to substantiate compliance with the mandatory compliance standards. This has led to a patchwork of varying evidentiary requirements across various jurisdictions of the territory.

### SUMMARY

In one example, a method includes identifying a compliance standard for the regulated entity based on a regulatory compliance monitoring and enforcement program report. The method also includes comparing evidentiary request packages to substantiate the compliance standard from a plurality of regulatory authorities including a first regulatory authority and a second regulatory authority. An evidentiary request package defines status indicators of parameters for the regulated entity to meet the compliance standard. A first evidentiary request package of the first regulatory authority is different than a second evidentiary request package of the second regulatory authority. The method further includes generating an inclusive evidentiary package based on the comparison. The method includes generating an evidentiary submittal package for the first regulatory authority based on the inclusive evidentiary package. The method yet further includes selecting an asset of the regulated entity based on the evidentiary submittal package. The method includes receiving operational data associated with the asset based on the evidentiary submittal package. The method also includes applying a compliance result to the compliance standard based on an analysis of the operational data.

Another example relates to a compliance standard system that includes a memory for storing machine-readable instructions and a processor. The processor accesses the machine-readable instructions and executes the machine-readable instructions as operations. The operations include identifying a compliance standard for the regulated entity based on a regulatory compliance monitoring and enforcement program report. The operations also include comparing evidentiary request packages to substantiate the compliance standard from a plurality of regional authorities including a first regional authority and a second regional authority. An evidentiary request package defines status indicators of parameters for the regulated entity to meet the compliance standard. A first evidentiary request package of the first regional authority is different than a second evidentiary request package of the second regional authority. The operations further include generating an inclusive evidentiary package based on the comparison. The operations include generating an evidentiary submittal package for the first regional authority based on the inclusive evidentiary package. The operations yet further include selecting an asset of the regulated entity based on the evidentiary submittal package. The operations include receiving operational data associated with the asset based on the evidentiary submittal package. The operations also include applying a compliance result to the compliance standard based on an analysis of the operational data.

In yet another example, a non-transitory machine-readable medium having machine executable instructions for compliance standard for the regulated entity causing a processor to execute operations. The operations include identifying a compliance standard for the regulated entity based on a regulatory compliance monitoring and enforcement program report. The operations also include comparing evidentiary request packages to substantiate the compliance standard from a plurality of regional authorities including a first regional authority and a second regional authority. An evidentiary request package defines status indicators of parameters for the regulated entity to meet the compliance standard. A first evidentiary request package of the first regional authority is different than a second request evidentiary package of the second regional authority. The operations further include generating an inclusive evidentiary package based on the comparison. The operations include generating an evidentiary submittal package for the first regional authority based on the inclusive evidentiary package. The operations yet further include selecting an asset of the regulated entity based on the evidentiary submittal package. The operations include receiving operational data associated with the asset based on the evidentiary submittal package. The operations also include applying a compliance result to the compliance standard based on an analysis of the operational data.

### BRIEF DESCRIPTION OF THE DRAWINGS

FIG. 1 illustrates a diagram of an example physical environment for a compliance standard system for the regulated entity.

FIG. 2 illustrates an example of an operating environment for a compliance standard system for the regulated entity.

FIG. 3 illustrates a regional authority map for a compliance standard system for the regulated entity.

FIG. 4 illustrates examples of evidentiary request packages for a compliance standard system.

FIG. 5 illustrates examples of evidentiary requests packages, an inclusive evidentiary package, and evidentiary submittal packages.

FIG. 6 illustrates a flowchart of an example method of substantiating compliance of compliance standards for the regulated entity.

### DETAILED DESCRIPTION

A compliance standard defines the expected operational values of assets that maintain a safe and reliable regulated entity in a territory of a centralized regulatory body. The regulated entity may operate in any regulated system such as utilities (e.g., water, cable, trash, sewer, cable, gas, electric, etc.), food and drug, aerospace, etc. A centralized regulatory authority monitors the operation and functioning of the regulated entity.

The centralized regulatory body delegates authority to a number of regulatory authority divisions. In one example of the divisions, the regulatory authorities are geographic areas of the territory. To substantiate that an asset within a geographic region is operating with the expected operational values, the regional authority given jurisdiction of that geographic area collects operational data associated with the asset. However, regional authorities have different evidentiary requirements to demonstrate compliance. Satisfying the different evidentiary requirements is manually intensive and time consuming. In particular, the different regional authorities have different evidentiary packages that include different parameters corresponding to different operational data. For example, a first regional authority requires that operational data for a first number of parameters be provided in a first evidentiary package to demonstrate compliance with the compliance standard. Concurrently, a second regional authority requires that operational data for a second number of parameters be provided in a second evidentiary package to demonstrate compliance with the same compliance standard. In this example, suppose that some of the parameters of the first number of parameters are different than the parameters of the second number of parameters. Accordingly, satisfying the compliance standard for the first regional authority includes harvesting different operational data than would be harvested for the parameters of the second regional authority.

This disclosure relates to a compliance standard system that is employable determine an inclusive evidentiary package that has a set of parameters that define status indicators for the regulated entity to meet the compliance standard in multiple jurisdictions of the territory. The inclusive evidentiary package is determined based on a comparison of evidentiary request packages from different regional authorities within the territory. For example, the comparison determines whether the first evidentiary request package or the second evidentiary request package has a larger number of parameters that would satisfy multiple regional authorities. As another example, the comparison identifies an evidentiary request package with the highest degree of overlapping parameters. Alternatively, the inclusive evidentiary package is generated to include a set of parameters common to the evidentiary request packages of the regional authorities. Therefore, the inclusive evidentiary package is selected or generated to include parameters that substantiate compliance with the compliance standard in multiple jurisdictions. An evidentiary submittal package is generated from the inclusive evidentiary package to include sufficient evidence to satisfy that specific regional authority. Accordingly, the compliance standard system mitigates the manually intensive and time-consuming effort of responding to the patchwork of different evidentiary packages by determining the inclusive evidentiary package that has parameters satisfying multiple regional authorities. For example, the inclusive evidentiary package is stored on the compliance standard system to reduce processing time and communication with the different regional authorities. More particularly, the inclusive evidentiary package avoids the need to recompute and/or re-acquire the same operational data that is to be provided multiple times to different regional authorities, in contrast to conventional approaches. The evidentiary submittal package for a specific regional authority is generated by accessing the stored inclusive evidentiary package.

As technologies used by the regulated entities change so do the compliance standards provided by a centralized regulatory authority of the territory. Consequently, the regional authorities change the parameters of evidentiary packages as a response to the changing technologies and compliance standards. The differences between the evidentiary packages can grow as regional authorities have different reactions to the changing landscape of technology and enforcement by the centralized regulatory authority. Accordingly, the compliance standard system monitors these changes to dynamically adapt the inclusive evidentiary package to the changing evidentiary requirements of the regional authorities.

The compliance standard system also receives operational data that monitors a status of critical infrastructure protection (CIP) assets. For example, the compliance standard system monitors a status of software patches deployed throughout a regulated entity. As another example, the compliance standard system provides a graphical user interface (GUI) that provides a map depicting a status of CIP assets throughout the power generation system. The compliance standard system may receive the operational data from an asset or from another asset that maintains, monitors, or stores operational data pertaining to the asset. For example, the operational data is received directly from an asset and/or is received from another asset that maintains a log of the functioning of the asset.

The operational data is analyzed to determine if the operational data satisfies the parameters of the inclusive evidentiary package. For example, a change in status to one of the software platforms that could bring a CIP asset offline or online. Alternatively, the change in status could indicate that a new CIP asset needs to be included in the regulatory compliance report and/or the removed CIP asset can be removed from the regulatory compliance report. The report is a regulatory compliance monitoring and enforcement program report. Accordingly, the status of the CIP asset is defined by the operational data corresponding to a parameter of the compliance standard, and the status indicator is compared to an expected operational value of the compliance standard. Based on the analysis of the operational data, a compliance result is applied to the compliance standard. For example, if the status indicator of the operational data corresponding to a parameter satisfies the expected operational value of the compliance standard, then the compliance result is “secure.” Conversely, if the status indicator of the operational data corresponding to a parameter does not satisfy the expected operational value of the compliance standard, then the operational data is classified as an anomaly based on an operational differential between the received operational data and the expected operational value. Based on an analysis of the anomaly the compliance result may be applied as “secure” or “vulnerable.”

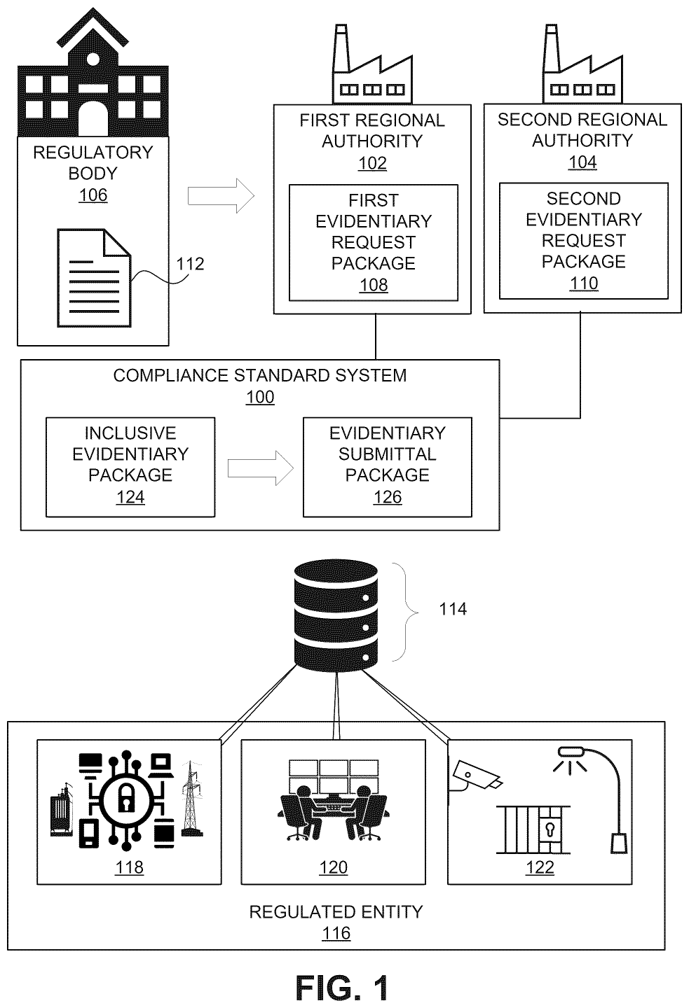

FIG. 1 illustrates a diagram of an example physical environment for a compliance standard system for a regulated entity. The compliance standard system 100 communicates with a number of regional authorities, including a first regional authority 102 and a second regional authority 104. The first regional authority 102 and the second regional authority 104 are divisions of a regulatory body 106. For example, the first regional authority 102 has a jurisdiction of a first geographical area of a territory of the regulatory body 106. The second regional authority 104 has a jurisdiction of a second geographical area of the territory different than the first geographical area.

Although described with respect to regional authorities as one example of regulatory authorities in FIG. 1, the regulatory authorities may be divided on the basis of other variances, such as political structure, assets, etc. In one example, the first regional authority 102 is a first regulatory authority representing a state or provincial government. The second regional authority 104 is a second regulatory authority representing a national or federal government. In another example, the first regional authority 102 is a first regulatory authority that represents a first set of assets (e.g., cyber assets). The second regional authority 104 is a second regulatory authority that represents a second set of assets (e.g., electronic security perimeter). Accordingly, the geographic regional authorities are one example of regulatory authority variance among others.

The first regional authority 102 is associated with a first evidentiary request package 108 and the second regional authority 104 is associated with a second evidentiary request package 110. The first evidentiary request package 108 and the second evidentiary request package 110 include sets of parameters that define status indicators of the operational data to meet a compliance standard based on a regulatory compliance monitoring and enforcement program report 112. In particular, the parameters of the first evidentiary request package 108 and the second evidentiary request package 110 specify the operational data that corresponds to the parameters.

The operational data is received from a centralized data warehouse 114 that communicates with a regulated entity 116. The regulated entity 116 includes the different assets such as cyber assets 118, electronic security perimeter assets 120, and physical security perimeter assets 122. The cyber assets 118 include any programmable electronic device, including hardware, or software, information, which are components of physical assets (e.g., facilities, renewable assets, electric utility assets, etc.) of the regulated entity 116 or enable the physical assets to function. For example, the cyber assets 118 include control systems of physical assets that manage, command, or regulate the behavior of processes of the physical assets. The cyber assets 118 may include data acquisition systems comprising collections of sensors and communication links that act to sample, collect, and provide data regarding the physical assets or a centralized location for display, archiving, or further processing.

The electronic security perimeter assets 120 protect an electronic boundary of the physical assets or cyber assets. For example, the electronic security perimeter assets include a proxy firewall, unified threat management firewall, next-generation firewall, etc. The physical security perimeter assets 122 protect a physical boundary of the physical assets or cyber assets and include, for example, cameras, video monitoring devices, motion sensors, intruder alarms, etc.

The regional authorities have jurisdiction over the assets 118-122 operating within the geographic region of the regional authority. The first regional authority has jurisdiction over the assets 118-122 in a first geographic area. The second regional authority has jurisdiction over the assets 118-122 in a second geographic area. Accordingly, the different regional authorities accommodate the geographic diversity of the assets 118-122. The geographic diversity further exacerbates the difference in the evidentiary packages between the regional authorities.

The evidentiary request packages are compared to substantiate the compliance standard from a plurality of regional authorities. For example, the first evidentiary request package 108 of the first regional authority 102 is compared to the second evidentiary request packages 110 of the second regional authority 104. An inclusive evidentiary package 124 is generated based on the comparison. The inclusive evidentiary package 124 is identified to satisfy the compliance standard in multiple jurisdictions. An evidentiary submittal package 126 is generated from the inclusive evidentiary package 124 to include sufficient evidence to satisfy a specific regional authority. The regional authorities utilize the evidentiary submittal package 126 to identify assets in the regulated entity 116. For example, the first regional authority 102 selects an asset 118-122 of the regulated entity 116 within the first geographic area of the first regional authority 102. Operational data of the asset is collected based on the evidentiary submittal package 126. In particular, status indicators that denote the status of the asset are received as operational data. The status indicators correspond to the parameters of the evidentiary submittal package 126. The compliance standard system 100 applies a compliance result to the compliance standard based on an analysis of the operational data.

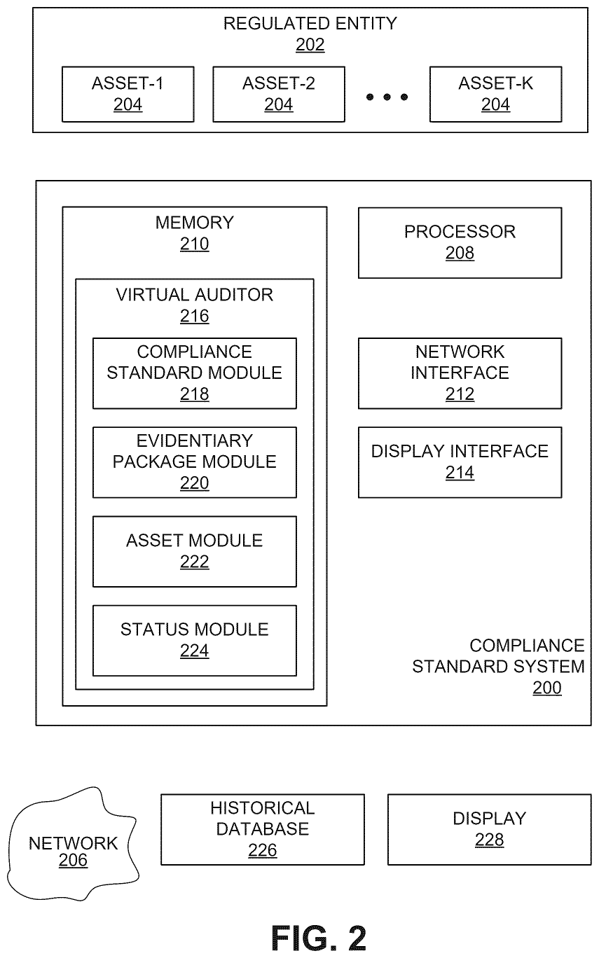

FIG. 2 illustrates an example of an operating environment for a compliance standard system 200 (e.g., the compliance standard system 100) for a regulated entity 202 (e.g., the regulated entity 116) having a number of assets 204. The compliance standard system 200 may represent application software executing on a computing platform of the operating environment. The compliance standard system 200 communicates with the assets 204 via a network 206. The network 206 is, for example, a data network, the Internet, a wide area network (WAN) or a local area (LAN) network. The network 206 serves as a communication medium to various remote devices (e.g., databases, web servers, remote servers, application servers, intermediary servers, client machines, other portable devices, etc.).

The compliance standard system 200 includes a processor 208, a memory 210, a network interface 212, and a display interface 214, which are operably connected for computer communication. The processor 208 processes signals and performs general computing to execute instructions stored in the memory 210. The instructions cause the processor 208 to execute operations. The processor 208 can be a variety of various processors including multiple single and multicore processors, co-processors, and other multiple single and multicore processor and co-processor architectures.

The memory 210 stores an operating system that controls or allocates resources of the compliance standard system. The memory 210 represents a non-transitory machine-readable medium (or other medium), such as RAM, a solid-state drive, a hard disk drive or a combination thereof. The memory 210 includes a virtual auditor 216 that includes modules that operate in concert and/or stages to substantiate compliance with a compliance standard. The modules include a compliance standard module 218, an evidentiary package module 220, an asset module 222, and a status module 224. The memory 210 stores machine-readable instructions associated with the modules 218-224. The processor 208 accesses the memory 210 and executes the machine-readable instructions as operations.

A module of the modules 218-224 may be an artificial neural network that acts as a framework for machine learning, including deep learning. For example, a module of the modules 218-224 may be a neural network, a convolution neural network (CNN) or a conditional generative adversarial network (cGAN). A module of the modules 218-224 may include an encoder, decoder, symbol predictor etc. For example, the evidentiary package module 220 may include an autoencoder, a long short-term memory (LSTM), or other artificial recurrent neural network that determines the representations to identify and select parameters of evidentiary packages in an unsupervised manner. The modules 218-224 may include convolutional layers and bi-directional LSTM layers compare and select evidentiary packages based on responses to previous regulatory compliance monitoring and enforcement program reports, for example, stored in a historical database 226. In various examples, the virtual auditor 216 can include more less of the modules.

The network interface 212 provides software and hardware to facilitate data input and output between the compliance standard system 200 and data sources, such as the regulated entity 202 via the network 206. The display interface 214 provides software and hardware to facilitate data input and output between the compliance standard system 100 and a display 228. The display 228 is a device for outputting information and may be a light-emitting diode (LED) display panels, liquid crystal display (LCD) panel, plasma display panels, and touch screen displays, among others. The display 228 includes graphical input controls for a user interface, which can include software and hardware-based controls, interfaces, touch screens, or touch pads or plug and play devices for an operator to interact with the virtual auditor 216.

The compliance standard module 218 identifies a compliance standard for a regulated entity 202 based on a regulatory compliance monitoring and enforcement program report (e.g., the regulatory compliance monitoring and enforcement program report 112 of FIG. 1). The compliance standard module 218 receives the regulatory compliance monitoring and enforcement program report from a centralized regulatory body (the regulatory body 106 of FIG. 1). In some examples, the regulatory compliance monitoring and enforcement program report is a North American Electric Reliability Corporation (NERC) standard.

The compliance standard module 218 can be implemented with a large language model (LLM) to digest a regulatory compliance monitoring and enforcement program report (e.g., NERC documents), region documents, industry partner documents and other (e.g., local) documents. Different regional authorities determine set of parameters for audit compliance based on the regulatory compliance monitoring and enforcement program reports. The LLM of the compliance standard system 200 may additionally digest previous responses, for example stored in the historical database 226, to regulatory compliance monitoring and enforcement program reports to determine which parameters were effective in substantiating compliance with the compliance standards of the regulatory compliance monitoring and enforcement program reports.

The compliance standard is a threshold requirement for the operations of assets 204 of the regulated entity 202. In one example, the compliance standard is that a security patch be installed on a first asset 204. The compliance standard is determined based on compliance standards identified from a regulatory compliance monitoring and enforcement program report and/or historical regulatory compliance monitoring and enforcement program reports. Historical regulatory compliance monitoring and enforcement program reports can also be stored in the historical database 226.

The evidentiary package module 220 receives evidentiary request packages from regional authorities including a first evidentiary request package (e.g., the first evidentiary request package 108) from the first regional authority (e.g., the first regional authority 102) and a second evidentiary request package (e.g., the second evidentiary request package 110) from the second regional authority (e.g., the first regional authority 102). The evidentiary request packages include parameters that, if satisfied by status indicators of the operational data, verify that the compliance standard is satisfied.

The first evidentiary request package has a first number of parameters, and the second evidentiary request package has a second number parameters. The first regional authority has different parameters in the first evidentiary request package than the second evidentiary request package of the second regional authority. For example, the first evidentiary request package includes a first parameter that denotes that the operational data demonstrate that the security patch is operational. The second evidentiary request package includes the first parameter that denotes that the operational data demonstrate that the security patch is operational but also a second parameter that denotes a log entry that verifies the date and time that the security patch was applied.

The evidentiary package module 220 identifies an inclusive evidentiary package (e.g., the inclusive evidentiary package 124 of FIG. 1) by comparing evidentiary request packages of the different regional authorities. The inclusive evidentiary package is the evidentiary package that is the most likely to satisfy the compliance standard in the most regional authorities. In one example, the comparison determines whether the first evidentiary request package or the second evidentiary request package has a larger number of parameters. In the example given above in which the first evidentiary request package has one parameter and the second evidentiary request package has two parameters, the second evidentiary request package would be identified as the inclusive evidentiary package. The second evidentiary request package is selected because the second evidentiary request package has a larger number of parameters. The inclusive evidentiary package is selected to comport with the evidentiary request packages of multiple regional authorities. In this example, the second evidentiary request package includes the parameters of the first evidentiary request package and also has the larger number of parameters. Therefore, satisfying the parameters of the second evidentiary request package for the second regional authority will satisfy the first evidentiary request package for the first regional authority. However, even in an example in which the second evidentiary request package has the largest number of parameters but does not include a parameter from the first evidentiary package, the additional evidence requirements of the second evidentiary package may satisfy another jurisdiction. Accordingly, the comparison determines the evidentiary package that is satisfying multiple regional authorities.

The compliance standard module 218 receiving an updated compliance standard triggers the evidentiary package module 220 to receive updated evidentiary request packages. In this manner, the compliance standard system 200 monitors changes to dynamically adapt to the changing evidentiary requirements. The evidentiary package module 220 thus adapts the inclusive evidentiary package to the changing evidentiary requirements of the regional authorities. In response to a regional authority performing an audit, the evidentiary package module 220 generates an evidentiary submittal package (e.g., the evidentiary submittal package 126 of FIG. 1) based on the inclusive evidentiary package. The evidentiary submittal package can be tailored to a specific regional authority. For example, the inclusive evidentiary package includes parameters from each of the regional authorities and the evidentiary submittal package is tailored to the auditing regional authority.

The asset module 222 selects an asset 204 of the regulated entity 202 based on the evidentiary submittal package. The asset module 222 selects assets with the operational data defined by the parameters. Continuing the example from above, the asset module 222 selects the first asset 204 on which the security patch was installed to retrieve the operational data that demonstrates that the security patch is operational. The asset module 222 may also select the first asset 204 for a log that includes a log entry verifying the date and time that the security patch was applied. In another example, the asset module 222 selects the first asset 204 for the operational data that demonstrates that the security patch is operational and a second asset 204 for the log.

The asset module 222 receives operational data from the selected asset(s) 204. Returning to the example of a security patch being applied, the asset module 222 retrieves operational data from asset 204 on which the security patch is applied based on a parameter of the evidentiary submittal package. If the security patch is a software update that is applied to asset 204 to run new or additional code, the asset module 222 requests operations data with a status indicator of the new or additional code in runtime. If the security patch is applied to close a port of the asset 204, the asset module 222 retrieves operational data that the status indicator of the port as closed or open. As another example, the asset module 222 retrieves or queries the log for the status indicator of the log entry. Consequently, the asset module 222 receives the operational data that corresponds to the parameters of the evidentiary submittal package.

The status module 224 applies a compliance result to the compliance standard based on an analysis of the operational data. For example, if the operational data includes the status indicator of the port of the asset 204, the status module 224 compares the status indicator of the operational data to the expected operational value of the compliance standard. For example, the expected operational value is “closed” to demonstrate that the security patch has been applied to the asset 204. The operational data is analyzed to determine if the status indicator comports with the expected operational value. If the operational data, such as a status indicator of a port of the asset 204 or a log entry, indicates that the port is closed, and therefore, satisfies the expected operational value of the compliance standard, then the status module 224 applies a compliance result indicating that the asset 204 is secure. If the operational data corresponding to the parameter does not satisfy the expected operational value of the compliance standard, for example that the port is open, then the status module 224 applies a compliance result, such as a vulnerable status, indicating that the asset 204 is vulnerable. Accordingly, the operational data is evaluated to determine that a security vulnerability is addressed, here that the security patch is deployed to the appropriately.

A difference between the status indicator of the operational data and the expected operational value defines an operational differential. An operational differential is identified as anomaly. The anomaly is classified as suspicious or as system noise based on the operational data and the operational differential. Continuing the example in which the compliance standard is that a security patch being installed on a first asset 204 to close a given port, the parameters of the evidentiary submittal package define reviewing packets received through the ports in a packet history. If the expected operational value is that no packets are received from the given port, the operational differential is the number of packets greater than zero being received, shown by a packet history. The status module 224 identifies the number of packets greater than zero as an anomaly.

In response to an anomaly being identified, the status module 224 classifies the anomaly as system noise or suspicious based on an operational differential. In one example, the classification is data-based. For example, if the packets are received from ports other than the given port, then the anomaly is classified as system noise because the received packets do not reflect the status of the given port. In response to the anomaly being classified as system noise, the status module 224 applies a compliance result indicating that the asset 204 is secure.

As another example, the classification is time-based. For example, the operational data is received from the asset, here the given port, at a first time and a second time, after the first time. At the first time the number of packets received from the given port is zero, and at a second time the number of packets received from the given port is greater than zero. Because the number of packets received increased above zero, the operational differential is increasing and denotes an anomaly. The anomaly is classified as suspicious based on an operational differential between the first time and the second time, specifically, the increase in packets received from the given port. In response to the anomaly being classified as suspicious, the status module 224 applies a compliance result of vulnerable status indicating that the asset 204 is vulnerable.

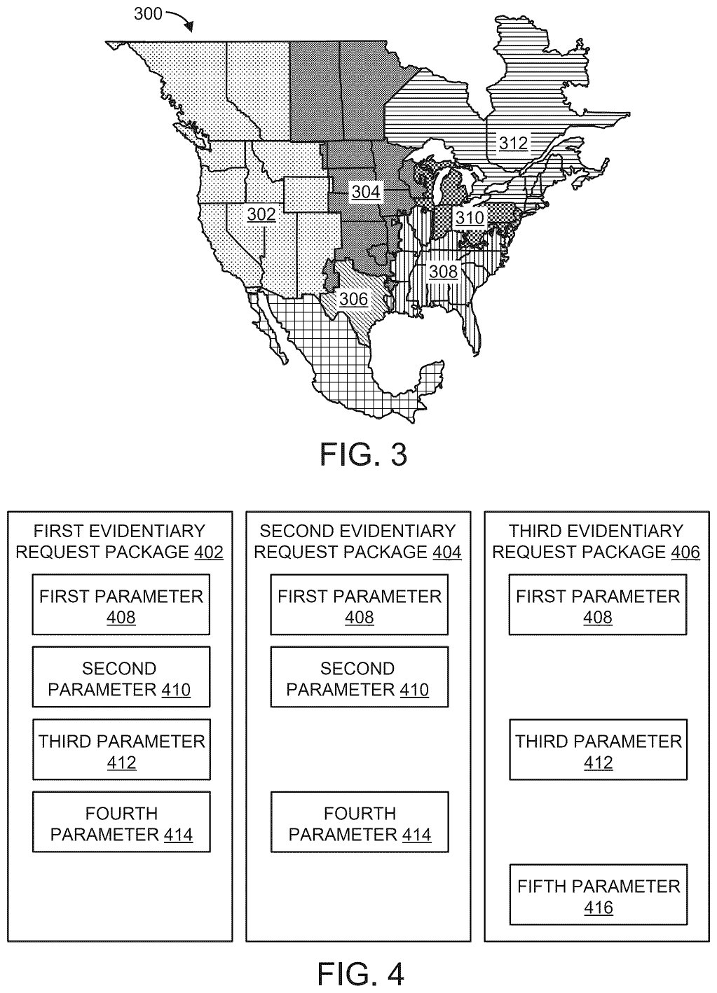

FIG. 3 illustrates a regional authority map 300 for a compliance standard system (e.g., the compliance standard system 100 of FIG. 1, the compliance standard system 200 of FIG. 2) for a regulated entity (e.g., the regulated entity 116, the regulated entity 202) having a number of assets (e.g., the cyber assets 118, electronic security perimeter assets 120, and physical security perimeter assets 122 of FIG. 1, the assets 204). While two regional authorities have been described, any number of regional authorities can communicate with the compliance standard system. For example, the regional authority map 300 includes a territory divided into geographic regions corresponding to regional authorities.

The geographic regions of the territory are the jurisdictions of regional authorities including a first regional authority 302 (e.g., the first regional authority 102 of FIG. 1), a second regional authority 304 (e.g., the second regional authority 104 of FIG. 1), a third regional authority 306, a fourth regional authority 308, a fifth regional authority 310, and a sixth regional authority 312. Any subset of the regional authorities 302-312 can provide an evidentiary request package for their geographic region as that geographic region is the jurisdiction of the corresponding regional authority. The evidentiary packages of different regional authorities may include different sets of parameters or subsets of parameters.

In another example, to geographic regional variances, the regional authorities may have different variances. Regional authorities may identify different types of entities. For example, the first regional authority 302 is an electrical utility and the second regional authority 304 is an electrical wholesaler, and the third regional authority 306 is an electrical infrastructure manufacturer.

FIG. 4 illustrates examples of different evidentiary request packages received by a compliance standard system (e.g., the compliance standard system 100 of FIG. 1, the compliance standard system 200 of FIG. 2) including a first evidentiary request package 402 (e.g., the first evidentiary request package 108 of FIG. 1) of a first regional authority, a second evidentiary request package 404 (e.g., the second evidentiary request package 110 of FIG. 1), and a third evidentiary request package 406. The evidentiary request packages 402-406 defines the evidence that substantiates the threshold requirement of the compliance standard as parameters. For example, if the compliance standard is that a security patch be installed on a first asset 204, the parameters define the evidence that would prove that the security patch was installed.

The evidentiary request packages 402-406 include a different number of parameters. The first evidentiary request package 402 has a first number of parameters and includes a first parameter 408, the second parameter 410, the third parameter 412, and a fourth parameter 414. The second evidentiary request package 404 has a second number of parameters and includes the first parameter 408, the second parameter 410, and the fourth parameter 414. The third evidentiary request package 406 has a third number of parameters and includes the first parameter 408, the second parameter 410, and the fifth parameter 416. The evidentiary package module (e.g., the evidentiary package module 220 of FIG. 2) compares the evidentiary request packages based on the parameters to substantiate the compliance standard from a plurality of regional authorities including a first regional authority and a second regional authority.

In one example, the comparison identifies an evidentiary request package having the largest number of parameters. In the example of FIG. 4, the first evidentiary request package 402 has four parameters whereas the second evidentiary request package 404 and the third evidentiary request package 406 have three parameters. Therefore, the first evidentiary request package is selected by an evidentiary package module as the inclusive evidentiary package based on the comparison.

In another example, the comparison determines which of the evidentiary request packages has the most parameters common to the other evidentiary request packages. In this example, whether the first evidentiary request package 402, the second evidentiary request package 404, or a third evidentiary request package 406 of a third regional authority (e.g., the third regional authority 306 of FIG. 3) has a set with the highest degree of overlapping parameters. The first evidentiary request package 402 includes each of the parameters of the second evidentiary request package 404 and includes two of the three parameters of the third evidentiary request package 406. The second evidentiary request package 404 has three of the four parameters of the first evidentiary request package 402 and only one of the parameters of the third evidentiary request package 406. The third evidentiary request package 406 has two of the four parameters of the first evidentiary request package 402 and one of the parameters of the second evidentiary request package 404. Because the first evidentiary request package 402 has the most parameters common to the other evidentiary request packages, here, the second evidentiary request package 404 and the third evidentiary request package 406, the first evidentiary request package 402 is selected by an evidentiary package module as the inclusive evidentiary package. Even though the first evidentiary request package 402 does not include the fifth parameter 416 of the third evidentiary request package 406, the first evidentiary request package includes additional parameters that are not included in the third evidentiary request package 406, specifically, the second parameter 410 and the fourth parameter 414. The first evidentiary request package 402 as the inclusive evidentiary package would satisfy the evidentiary requirements of the third regional authority corresponding to the third evidentiary request package 406 despite lacking the fifth parameter 416 due to the inclusion of the second parameter 410 and the fourth parameter 414.

In a further example, identifying the inclusive evidentiary package includes generating the inclusive evidentiary package with parameters from the first evidentiary request package and the second evidentiary request package. As discussed above, the first evidentiary request package 402 includes each of the parameters of the second evidentiary request package 404 and includes two of the three parameters of the third evidentiary request package 406. In one example, the evidentiary package module generates an inclusive evidentiary package that includes the parameters of the first evidentiary request package 402 and any parameters of the other evidentiary packages that are not included in the first evidentiary request package 402, such as the fifth parameter 416 of the third evidentiary request package 406. Accordingly, the inclusive evidentiary package is generated to satisfy the parameters requested by each of the regional authorities.

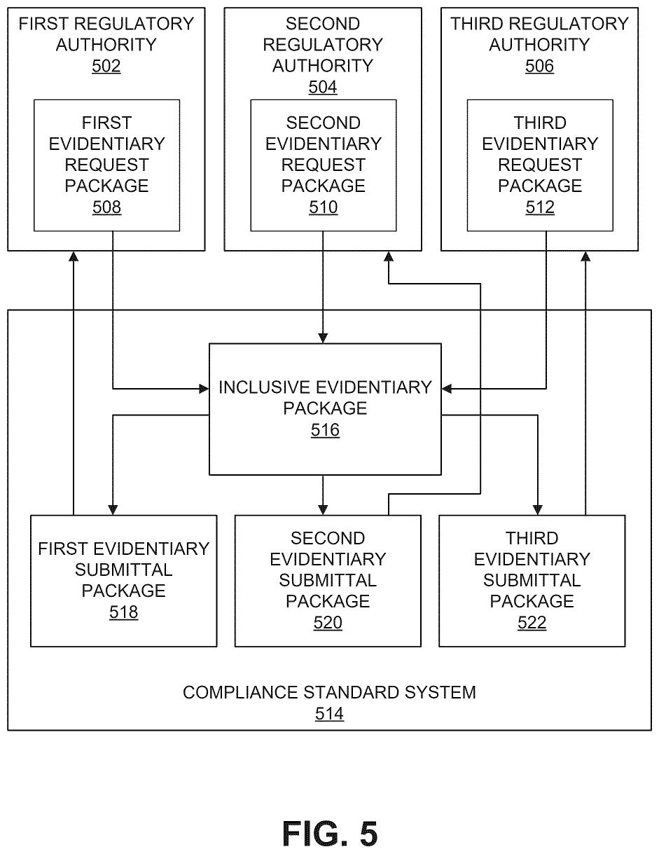

FIG. 5 illustrates examples of evidentiary request packages, an inclusive evidentiary package, and evidentiary submittal packages corresponding to the evidentiary request packages. The different regulatory authorities request evidence using different evidentiary request packages. The regulatory authorities may be regional authorities or represent other regional authority variances. For example, the regional authorities include a first regulatory authority 502 (e.g., the first regional authority 102 of FIG. 1, the first regional authority 302 of FIG. 3), a second regulatory authority (e.g., the second regional authority 104 of FIG. 1, the second regional authority 304 of FIG. 3), and a third regulatory authority 506.

As described above with respect to FIG. 4, the different evidentiary request packages include parameters that define status indicators for the regulated entity to meet the compliance standard. The first regulatory authority 502 has a first evidentiary request package 508 (e.g., the first evidentiary request package 108 of FIG. 1, the first evidentiary request package 402 of FIG. 4). The second regulatory authority 504 has a second evidentiary request package 510 (e.g., the second evidentiary request package 110 of FIG. 1, the second evidentiary request package 404 of FIG. 4). The third regulatory authority 506 has a third evidentiary request package 512 (e.g., the third evidentiary request package 406 of FIG. 4).

A compliance standard system 514 (e.g., the compliance standard system 100 of FIG. 1, the compliance standard system 200 of FIG. 2) for a regulated entity (e.g., the regulated entity 116, the regulated entity 202) receives the evidentiary request packages 508-512. The compliance standard system 514 generates the inclusive evidentiary package 516 (e.g., the inclusive evidentiary package 124 of FIG. 1). The inclusive evidentiary package 516 includes parameters from a plurality of regulatory authorities of the regulatory authorities 502-506. In some examples, the inclusive evidentiary package 516 includes parameters from all of the regulatory authorities 502-506. Therefore, the inclusive evidentiary package 516 includes parameters that would satisfy each of the regulatory authorities 502-506.

The compliance standard system 514 generates evidentiary submittal packages for the regulatory authorities based on the inclusive evidentiary package 516. For example, the first evidentiary submittal package 518 is generated for the first regulatory authority 502, the second evidentiary submittal package 520 is generated for the second regulatory authority 504, and the third evidentiary submittal package 522 is generated for the third regulatory authority 506. The evidentiary submittal packages 518-522 include parameters from the inclusive evidentiary package 516.

The parameters included in the evidentiary submittal package may correspond to the parameters of the evidentiary request package. For example, the parameters of the first evidentiary submittal package 518 correspond to the parameters of the first evidentiary request package 508. In another example, the parameters of the first evidentiary submittal package 518 includes fewer parameters than the first evidentiary request package 508. For instance, suppose that the first evidentiary request package 508 includes three alternative parameters to satisfy the compliance standard. The first evidentiary submittal package 518 includes one of the alternative parameters. In another example, the parameters of the first evidentiary submittal package 518 include more parameters than the first evidentiary request package 508. In this example, suppose that the first evidentiary request package 508 includes a single parameter to satisfy the compliance standard but other evidentiary request packages includes multiple parameters to satisfy the compliance standard. The first evidentiary submittal package 518 includes at least two parameters. Accordingly, the evidentiary submittal packages 518-522 include at least some of the parameters of the inclusive evidentiary package 516 based on the evidentiary request packages 508-512.

Because the inclusive evidentiary package 516 is generated by the compliance standard system 514, the evidentiary submittal packages are generated with the compliance standard system 514. This reduces the need for communication with various regulatory authorities, thereby reducing the processing resources to generate the evidentiary submittal packages 518-522. Additionally, generation of the inclusive evidentiary package 516 avoids the need to retrieve and/or otherwise re-acquire the operational data multiple times to generate the evidentiary submittal packages 518-522 for the different regulatory authorities 502-506, in contrast to conventional approaches.

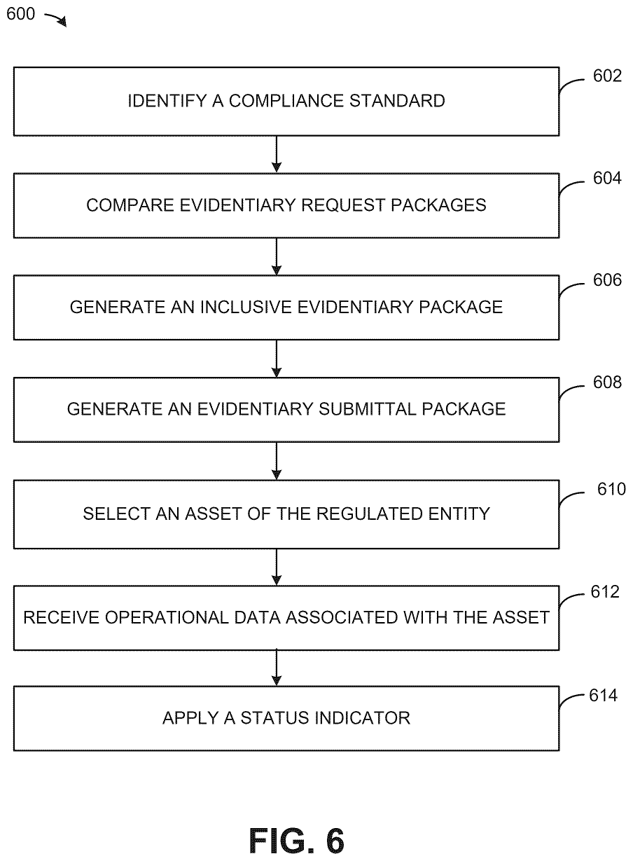

FIG. 6 illustrates a flowchart of an example method 600 for substantiating compliance of compliance standards for the regulated entity. FIG. 6 will also be described with reference to FIGS. 1-5. For simplicity, the method 600 will be described as a sequence of blocks, but it is understood that the elements of the method 600 can be organized into different architectures, elements, stages, and/or processes. For purposes of simplification, FIGS. 1-5 employ the same reference numbers to denote the same structure.

At block 602, the method 600 includes identifying a compliance standard for a regulated entity (e.g. the regulated entity 116 of FIG. 1, the regulated entity 202 of FIG. 2) based on a regulatory compliance monitoring and enforcement program report (e.g., the regulatory compliance monitoring and enforcement program report 112 of FIG. 1). The regulatory compliance monitoring and enforcement program report sets a compliance standard for the territory of a centralized regulatory body (e.g., the regulatory body 106 of FIG. 1).

At block 604, the method 600 includes comparing evidentiary request packages to substantiate the compliance standard from a plurality of regulatory authorities including a first regulatory authority (e.g., the first regional authority 102 of FIG. 1, the first regional authority 302 of FIG. 3, the first regulatory authority 502 of FIG. 5) and a second regulatory authority (e.g., the second regional authority 104 of FIG. 1, the second regional authority 304 of FIG. 3, the second regulatory authority 504 of FIG. 5). Additionally, evidentiary request packages may be received from a third regulatory authority (e.g., the third regional authority 306 of FIG. 3, the third regulatory authority 506 of FIG. 5), a fourth regulatory authority (e.g., the fourth regional authority 308 of FIG. 3), etc. An evidentiary request package defines parameters that define status indicators for the regulated entity to meet the compliance standard. The comparison determines the differences between the evidentiary request packages, including first evidentiary request package of the first regulatory authority and the second evidentiary request package of the second regulatory authority.

At block 606, the method 600 includes generating an inclusive evidentiary package based on the comparison of the evidentiary request packages. In one example, the comparison determines whether the first evidentiary request package or the second evidentiary request package has a larger number of parameters. In another example, the comparison determines whether the first evidentiary request package, the second evidentiary request package, or a third evidentiary request package of third regulatory authority has a set with this highest degree of overlapping parameters. In a further example, identifying the inclusive evidentiary package includes generating the inclusive evidentiary package with parameters from the first evidentiary package and the second evidentiary package. The inclusive evidentiary package is stored in a memory of a compliance standard system (e.g., the compliance standard system 100 of FIG. 1, the compliance standard system 200 of FIG. 2).

At block 608, the method 600 includes generating a first evidentiary submittal package for the first regulatory authority based on the inclusive evidentiary package. The first evidentiary submittal package is generated to include parameters of the inclusive evidentiary package based on the evidentiary request packages of the first regulatory authority. Alternatively, the first evidentiary submittal package includes parameters of the inclusive evidentiary package based on the evidentiary request packages of other regulatory authorities.

At block 610, the method 600 includes selecting an asset (e.g., a cyber asset 118, an electronic security perimeter asset 120, a physical security perimeter asset 122, the assets 204) of the regulated entity based on the inclusive evidentiary package. In some examples, the parameters may identify the assets that have the operational data corresponding to the parameters of the inclusive evidentiary package. In another example, the location of the operational data may be identified based on the responses to previous a regulatory compliance monitoring and enforcement program report.

At block 612, the method 600 includes receiving operational data associated with the asset based on the inclusive evidentiary package. As one example, the operational data may be received from a centralized data warehouse (e.g., the centralized data warehouse 114 of FIG. 1). As another example, the operational data may be received directly from assets.

At block 614, the method 600 includes applying a compliance result to the compliance standard based on an analysis of the operational data. In response the compliance result, the control parameters of the asset are updated to cause the asset to alter operation of the asset. The control parameters alter the functioning, operation, or execution of the asset. For example, a control parameter may cause the asset to update security functions, such as causing the asset to update software. Thus, the control or monitoring parameters of the asset are updated based on the compliance result to cause the asset to alter operation or monitoring of the asset.

In another example, a user receives a notification of the compliance result. The compliance result is provided to the user via the display (e.g., the display 228 of FIG. 2) and includes, for example, a compliance map depicting a status of assets throughout the territory annotated with the compliance result. Accordingly, the compliance map is provided in an easy to digest format that can enable the user to detect a potential future non-compliance with the regulatory compliance monitoring and enforcement program report, such as the NERC audit.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

A “value” as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value of X may be given as a percentage between 0% and 100%. In other cases, the value of X could be a value in the range between 1 and 10. In still other cases, the value of X may not be a numerical value, but could be associated with a given discrete state, such as “not X”, “slightly x”, “x”, “very x” and “extremely x”.

In this description, unless otherwise stated, “about,” “approximately” or “substantially” preceding a parameter means being within +/−10 percent of that parameter. Modifications are possible in the described embodiments, and other embodiments are possible, within the scope of the claims.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method comprising:
identifying a compliance standard for a regulated entity based on a regulatory compliance monitoring and enforcement program report;
comparing evidentiary request packages to substantiate the compliance standard from a plurality of regulatory authorities including a first regulatory authority and a second regulatory authority, wherein an evidentiary request package defines status indicators of parameters for the regulated entity to meet the compliance standard, and wherein a first evidentiary request package of the first regulatory authority is different than a second evidentiary request package of the second regulatory authority;
generating an inclusive evidentiary package based on the comparison;
generating an evidentiary submittal package for the first regulatory authority based on the inclusive evidentiary package;
selecting an asset of the regulated entity based on the evidentiary submittal package;
receiving operational data associated with the asset based on the evidentiary submittal package; and
applying a compliance result to the compliance standard based on an analysis of the operational data.

2. The method of claim 1, wherein the operational data is received from the asset at a first time and from the asset at a second time after the first time, the analysis includes analyzing the operational data of the asset to identify an anomaly, the method further comprising:
classifying the anomaly as system noise or suspicious based on an operational differential between the first time and the second time.

3. The method of claim 2, wherein the compliance result applied is a vulnerable status in response to the anomaly being classified as suspicious.

4. The method of claim 1, wherein the first evidentiary request package has a first number of parameters and the second evidentiary request package has a second number parameters, wherein the comparison determines whether the first evidentiary request package or the second evidentiary request package has a larger number of parameters.

5. The method of claim 1, wherein the inclusive evidentiary package is stored in a memory, and generating the evidentiary submittal package includes accessing the memory.

6. The method of claim 1, wherein the first evidentiary request package includes a first set of parameters, the second evidentiary request package include a second set of parameters, and a third evidentiary request package includes a third set of parameters, and wherein the comparison determines whether the first evidentiary request package, the second evidentiary request package, or the third evidentiary request package has a set with this highest degree of overlapping parameters.

7. The method of claim 1, wherein identifying the inclusive evidentiary package further comprises generating the inclusive evidentiary package with parameters from the first evidentiary request package and the second evidentiary request package.

8. The method of claim 1, further comprising:
updating control or monitoring parameters of the asset based on the compliance result to cause the asset to alter operation or monitoring of the asset.

9. The method of claim 8, wherein the control or monitoring parameters cause the asset to update security functions.

10. A compliance standard system comprising:
a memory for storing machine-readable instructions; and
a processor for accessing the machine-readable instructions and executing the machine-readable instructions as operations, the operations comprising:
identifying a compliance standard for a regulated entity based on a regulatory compliance monitoring and enforcement program report;
comparing evidentiary request packages to substantiate the compliance standard from a plurality of regional authorities including a first regional authority and a second regional authority, wherein an evidentiary request package defines status indicators of parameters for the regulated entity to meet the compliance standard, and wherein a first evidentiary request package of the first regional authority is different than a second evidentiary request package of the second regional authority;
generating an inclusive evidentiary package based on the comparison;
generating an evidentiary submittal package for the first regional authority based on the inclusive evidentiary package;
selecting an asset of the regulated entity based on the evidentiary submittal package;
receiving operational data associated with the asset based on the evidentiary submittal package; and
applying a compliance result to the compliance standard based on an analysis of the operational data.

11. The compliance standard system of claim 10, wherein the operational data is received from the asset at a first time and from the asset at a second time after the first time, the analysis includes analyzing the operational data of the asset to identify an anomaly, the operations further comprising:
classifying the anomaly as system noise or suspicious based on an operational differential between the first time and the second time.

12. The compliance standard system of claim 11, wherein the compliance result applied is a vulnerable status in response to the anomaly being classified as suspicious.

13. The compliance standard system of claim 10, wherein the first evidentiary request package has a first number of parameters and the second evidentiary request package has a second number parameters, wherein the comparison determines whether the first evidentiary request package or the second evidentiary request package has a larger number of parameters.

14. The compliance standard system of claim 10, wherein the inclusive evidentiary package is stored in the memory, and generating the evidentiary submittal package includes accessing the memory.

15. The compliance standard system of claim 10, the operations further comprising: further comprising:
updating control or monitoring parameters of the asset based on the compliance result to cause the asset to alter operation or monitoring of the asset.

16. A non-transitory machine-readable medium having machine executable instructions for a virtual auditor causing a processor to execute operations, the operations comprising:
identifying a compliance standard for a regulated entity based on a regulatory compliance monitoring and enforcement program report;
comparing evidentiary request packages to substantiate the compliance standard from a plurality of regional authorities including a first regional authority and a second regional authority, wherein an evidentiary request package defines status indicators of parameters for the regulated entity to meet the compliance standard, and wherein a first evidentiary request package of the first regional authority is different than a second evidentiary request package of the second regional authority;
generating an inclusive evidentiary package based on the comparison;
generating an evidentiary submittal package for the first regional authority based on the inclusive evidentiary package;
selecting an asset of the regulated entity based on the evidentiary submittal package;
receiving operational data associated with the asset based on the evidentiary submittal package; and
applying a compliance result to the compliance standard based on an analysis of the operational data.

17. The non-transitory machine-readable medium of claim 16, wherein the operational data is received from the asset at a first time and from the asset at a second time after the first time, the analysis includes analyzing the operational data of the asset to identify anomaly, the operations further comprising:
classifying the anomaly as system noise or suspicious based on an operational differential between the first time and the second time.

18. The non-transitory machine-readable medium of claim 17, wherein the compliance result applied is a vulnerable status in response to the anomaly being classified as suspicious.

19. The non-transitory machine-readable medium of claim 16, the operations further comprising:
updating control or monitoring parameters of the asset based on the compliance result to cause the asset to alter operation or monitoring of the asset.

20. The non-transitory machine-readable medium of claim 19, wherein the control or monitoring parameters cause the asset to update security functions.
